(19) United States
(12) Patent Application Publication
(10) Pub. No.: US 2007/0003444 A1
(43) Pub. Date: Jan. 4, 2007

(54) Laminated device

(76) Inventors: Steven Howell, Bedford (GB); Aman Khan, Bedford (GB); Paul Perry, Bedford (GB); Andrew Peter Phelan, Bedford (GB); James Troke, Bedford (GB)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/436,412

(22) Filed: May 18, 2006

Related U.S. Application Data
(63) Continuation of application No. PCT/GB04/04843, filed on Nov. 18, 2004.

(30) Foreign Application Priority Data
Nov. 21, 2003 (GB) 0327094.9

(51) Int. Cl. B01L 3/00

(52) U.S. Cl. 422/100

(57) ABSTRACT

A microfluidic device is made up from at least four laminae, the laminae including two outer laminae and at least two further laminae disposed between the outer laminae and defining a microfluidic pathway. Inner surfaces of the outer laminae define the upper and lower surfaces of a fluid pathway, one of said further laminae defining at least a first fluidic element, and at least a second of said further laminae defining at least a second fluidic element, wherein the first and second fluidic elements are fluidically coupled.

### CROSS-REFERENCE TO RELATED APPLICATIONS

This application claims priority to PCT/GB2004/004843, filed on Nov. 18, 2004; which claims priority to GB 0327094.9, filed Nov. 21, 2003, the contents of which are specifically incorporated herein.

### FIELD OF INVENTION

The invention is concerned with a microfluidic device and a method of making such a device. In particular but not exclusively the invention concerns a diagnostic device suitable for the measurement of analytes in or for the measurement of the properties of a fluid sample, such as a sample of bodily fluid.

### BACKGROUND

Simple disposable diagnostic devices suitable for the measurement of analytes in sample of bodily fluids are known and typically comprise a measurement or reaction chamber, a suitable vent and a fluid conduit for delivery of the sample fluid to the chamber, see for example EP537761. The dimensions of the fluidic pathway will typically have at least one capillary dimension such that fluid may proceed along the fluid pathway by capillary action, requiring no or minimal external forces. The internal fluid volume space may be achieved by providing a sidewall spacer between upper and lower laminae. The height of the sidewall spacer will effectively define the height of the fluidic channel. The side wall spacer may be formed for example by printing a glue spacer onto an internal surface of one or both the laminae or the spacer may itself be formed of a solid material. Such devices may be individually produced or mass-produced using large sheets of substrate materials that may be laminated using either a batch or continuous process and subsequently cut to produce the desired devices.

Such devices are typically small and designed to be suitable for use with fluid samples of volumes typically between 1-50uL.

### OUTLINE OF THE INVENTION

The present inventors have realised that one of the problems that arises when dosing reagent into a reaction chamber is one of containment of the reagent. Liquids that are dosed into the reagent chamber have a tendency to move or be drawn into the fluid conduit that connects the chamber. This occurs due to capillary forces that exist at the chamber/conduit interface and can lead to the fluid conduit being partially or completely blocked by reagent, resulting in inferior fluid flow characteristics within the device. This is particularly a problem when dosing into a very small chamber, as it is difficult to ensure that the liquid comprising or containing the reagent does not contact the sides of the chamber and/or the fluid conduit/chamber interface leading to capillary movement of the reagent into the fluid conduit. The problems of accurate dosing are also exacerbated when manufacturing devices on a large scale using automated equipment. One possible way around the problem is to design the chamber to be of a larger cross-sectional area. However, this results in a larger chamber volume requiring a larger volume of fluid test sample. Another solution is to create a chamber having a depth greater than minimum depth required for capillary flow, i.e. a depth greater than a capillary dimension. This however has drawbacks in that it also results in a larger chamber thus requiring a larger volume of fluid sample. Furthermore it is difficult to move sample fluid from a region of high capillarity within the fluid conduit to one of low capillarity in the fluid chamber.

It is a desirable feature of a diagnostic testing device that the volume of fluid sample required be as low as possible. This is particularly so for collection of samples of bodily fluid, such as samples of capillary blood from a finger stick or lancet, as collection of large volumes prove to be painful for the patient. A further drawback of providing larger fluid chambers is that the device becomes structurally weaker due to the presence of less substrate per unit area. This effect becomes greater for devices having multiple chambers and/or fluid conduits.

The invention provides for a microfluidic diagnostic device and relatively simple, low cost method of manufacture. The invention is particularly suited to devices having more than one chamber and/or fluid conduit.

In one aspect the invention provides a microfluidic device comprising at least four laminae, the laminae including two outer laminae and at least two further laminae disposed between the outer laminae and defining a microfluidic pathway wherein inner surfaces of the outer laminae define the upper and lower surfaces of a fluid pathway, a one of said further laminae defining at least a first fluidic element, and at least a second of said further laminae defining at least a second fluidic element, wherein the first and second fluidic elements are fluidically coupled.

The device may have at least three further laminae wherein each further laminae defines at least a respective one microfluidic element.

A reagent may be provided in one or more of the microfluidic elements.

In a second aspect the invention provides a method of constructing a microfluidic device comprising providing at least a first lamina or lamina assembly which serves to define at least a first microfluidic element or area; providing at least a second lamina or lamina assembly which serves to define at least a second microfluidic element or area; and connecting the at least first and second laminae or laminate sub-assemblies such that the first and second microfluidic elements become fluidically coupled.

Prior to connection of the first and second laminae or lamina assemblies, a reagent may be dispensed into one of the microfluidic elements.

The reagent may be disposed in the particular microfluidic element or elements in a liquid form or dispersed or dissolved in a suitable liquid carrier or liquid solvent.

In one embodiment, one of the microfluidic elements is of a higher capillarity than the other. Reagent may be disposed in the microfluidic element having a lower capillarity.

The microfluidic element having a lower capillarity may be a fluid chamber and the microfluidic element having a higher capillarity a fluid conduit.

In another embodiment, the microfluidic elements are of the same capillarity.

Reagents may be dispensed into both of the or respectively each microfluidic element.

The invention also relates to a microfluidic device prepared according to the second aspect, and to a diagnostic assay device prepared according to the second aspect

According to another aspect, the invention provides for a microfluidic diagnostic assay device and method of construction thereof comprising the steps of:
(a) provision of first and second laminae or lamina sub-assemblies which respectively serve to contain or define first and second microfluidic elements;
(b) dosing of a reagent into the first and/or second microfluidic elements;
(c) assembling the first and second laminae or lamina sub-assemblies such that the respective microfluidic elements become fluidically coupled.

According to a further aspect, the microfluidic element may be defined by one portion of a lamina or lamina sub-assembly and a further microfluidic element may be defined by another portion of the same lamina or lamina sub-assembly. The laminated structure may then be folded so as to fluidically couple the microfluidic elements. The invention need not necessarily be limited to one fold, and more folds could be provided if desired. The substrate could for example be folded in half upon itself to provide two laminae, or the substrate could be partially folded such that the lower lamina were bigger in cross-sectional area than the upper lamina or vice-versa. Thus in principle the entire diagnostic device could be provided from one substrate. Alternatively, the folded lamina could be used to produce a sub-lamina assembly to which further laminae or lamina sub-assemblies could be attached.

The reagent would be applied to one of the microfluidic elements prior to the folding of the substrate and fluidic coupling of the microfluidic elements.

An advantage provided by this folding method is that all of the microfluidic elements may be provided on the one lamina or lamina sub-assembly if desired. A further advantage is that it removes the need for precise location of the individual laminae. This is especially so for structures having very small microfluidic elements, wherein precise location is essential to ensure effectively fluidic communication from one microfluidic element to another.

The term microfluidic element is intended to refer to any microfluidic structure through which fluid sample may flow through or into and includes but is not restricted to, a vent for the venting of gases, chamber, channel, conduit, filter, time gate and so on. The microfluidic element may be of regular or irregular dimensions.

Preferably the microfluidic elements will have at least one capillary dimension such that fluid is able to flow along and pass from one microfluidic element to another under the influence of capillary action. Alternatively or additionally the fluid sample may be caused to flow along or between microfluidic elements under the influence of other forces such as gravity, electro-kinetic or electro-osmotic pumping and so on.

Typical dimensions of the microfluidic elements are those having a cross-sectional dimension, such as a cross-sectional diameter, of between 0.1 and 500 um, more typically having a cross-sectional dimension of between 1 and 100 um.

A key aspect of the invention is the provision of a microfluidic device and method of manufacture thereof wherein key microfluidic elements that make up the microfluidic only become fluidically coupled upon assembly of the device, namely upon attachment of the various sections, laminae or lamina sub-assemblies that define the respective microfluidic elements.

By separation of the key microfluidic elements, reagent that is deposited into a particular microfluidic element is not able to flow into a second microfluidic element. This serves to contain the reagent in the particular microfluidic element. This is particularly advantageous in cases where it is necessary to contain the reagent in a particular microfluidic element or where flow of reagent from one microfluidic element into another or flow of reagent into the interface between two microfluidic elements may cause the microfluidic flow path to be impeded or blocked. This is especially true of microfluidic elements which have at least a capillary dimension, such that reagent is able to flow from one to another by capillary action. This effect may be magnified where for example reagent is dosed into a microfluidic element having a particular capillary force such as a chamber that is fluidically coupled and adjacent to a microfluidic element having a greater capillary force, such as a fluid conduit having a smaller cross-sectional dimension. Thus according to a further aspect, the invention provides for a microfluidic device and method of construction thereof wherein reagent provided in a first microfluidic element is subsequently fluidically coupled to a second microfluidic element wherein the second microfluidic element has a higher capillarity than the first microfluidic element or wherein the second microfluidic element has a region of higher capillarity which is positioned adjacent a first microfluidic element having a region of lower capillarity.

By separation of the key microfluidic elements, it removes the need to dose reagent into a microfluidic element so accurately, for example it removes the need to dose reagent such that it would not have a tendency to flow (for example by ensuring that it did not touch the side walls of the element). This is especially advantageous when dosing reagent into elements of very small volume which may be of the order of 100 nl or greater.

The term key microfluidic elements is intended to refer to those microfluidic elements in which it is desirable to keep separate during assembly. Thus for example, there may not be a need to necessarily separate particular microfluidic elements from one another, in particular microfluidic elements which are not situated adjacent to microfluidic elements into which reagent will be dosed. For example, one lamina may be provided with a fluid application element that is fluidically coupled to a fluid conduit element. A second lamina could then be provided with a chamber element into which reagent is dosed, followed by assembly of the first and second laminae such that the fluid chamber becomes fluidically coupled and situated adjacent to the fluid conduit and be fluidically coupled and situated remote from the fluid application element.

The invention is not necessarily restricted to two laminae or lamina sub-assemblies and the various microfluidic elements may be provided in any number of laminae. The individual laminae may comprise more than one microfluidic element if desired which may or may not be in fluidic connection with each other.

The reagents may specifically or non-specifically react or bind with an analyte of interest or serve to modify a property of the fluid sample such as viscosity or pH. Non-limiting examples of reagents that could be employed are specific binding partners to the analyte of interest such as antibodies, binding proteins, antigens and the like, enzymes, reagents that serve to influence a property of hemostasis of a fluid sample such as thromboplastin, or reagents that serve to interact with the fluid sample or analytes contained therein in any way or to enable the measurement to take place such as magnetic or magnetisable particles.

The diagnostic assay device according to the invention is suitable for the measurement of the amount or presence of analyte in or for the measurement of the properties of a fluid sample, such as a sample of bodily fluid.

A particular microfluidic element may also serve to hold the fluid sample such that the property of the sample or analytes contained therein might be determined. Typically this might be carried out in a fluid chamber element. The manner by which the particular parameter of interest could be determined or measured could be for example by optical means, electrochemical means, magnetic means, by the use of a piezoelectric crystal and so on. The chamber would be arranged to contain or cooperate with suitable transduction means, such as suitably positioned optics or electrodes.

Examples of analytes include hormones, drugs, bacteria, toxins, organic compounds, proteins, peptides, micro organisms, bacteria, viruses, amino acids, nucleic acids, carbohydrates, hormones, steroids, vitamins, pollutants, pesticides, and metabolites of or antibodies to any of the above substances and so on.

The fluid sample for use in the diagnostic assay device can be derived from any source, such as a physiological fluid, including blood, serum, plasma, saliva, interstitial fluid, ocular lens fluid, sweat, urine, and the like. Besides physiological fluids, other samples can be used such as water, food products, soil extracts, and the like for the performance of industrial, environmental, or food production assays as well as diagnostic assays. In addition, a solid material suspected of containing the analyte can be used as the test sample once it is modified to form a liquid medium or to release the analyte.

Dosing of reagents into the reaction chambers may be achieved using a number of techniques known in the art such as screen-printing, pen plotting or airbrushing. The reagent may be applied in a liquid, semi-liquid, gel or semi-solid form and/or be dispersed or dissolved in a suitable liquid carrier or solvent as required. More than one reagent may be added. For example, in the case of a diagnostic assay for the measurement of coagulation time, thromboplastin may be added along with magnetic particles.

If desired the solvent or carrier may be removed or partially removed to yield a dry reagent or a reagent that is substantially immobile before the device is assembled and the key microfluidic elements are fluidically coupled.

The microfluidic structures may be created for example by embossing methods such as stamping a particular substrate, lamina or lamina sub-assembly. This method removes the need to provide upper and lower laminated which serve to seal and the microfluidic elements. Alternatively, the microfluidic elements may be defined by cutting entirely through the thickness of the particular laminae. In this case, upper and lower laminae may be provided in order to seal the microfluidic elements, as exemplified by laminae (1) and (4) in FIG. 1.

The laminae making up the device may be chosen to be of any suitable material such as polycarbonate. The laminae may be treated where necessary to increase their hydrophilicity, for example by the provision of a suitable surface coating. The dimensions of the lamina, namely thickness, length or width may be chosen to be any suitable. The individual dimensions and materials of the laminae may be chosen to be the same or chosen to be different. The thickness of the individual laminae might typically range from around 50 uM to around 200 uM although in principle any thickness could be contemplated.

A suitable method to attach the laminae to each other is to provide an adhesive on one or both surfaces of the respective laminae. The adhesive may also be hydrophilic which may serve to provide enhanced flow characteristics of the fluid sample. The individual laminae may be provided for example with an adhesive coating and with a further backing lamina. Removal of this backing lamina thus reveals the adhesive coating.

According to one embodiment the diagnostic device is constructed from four laminae comprising upper and lower laminae which serve to define the upper and lower surfaces of the fluid pathway, a first intermediate lamina comprising at least one channel and a second intermediate lamina comprising at least a chamber. The intermediate laminae may be provided in any order.

### BRIEF DESCRIPTION OF THE DRAWINGS

Examples incorporating the invention will now be described with reference to the accompanying drawings, in which:

FIG. 1 shows a perspective exploded view of a device embodying the invention;

FIG. 2 shows a perspective exploded view of a second device embodying the invention;

FIG. 3 shows a cross-sectional view of a laminated device embodying the invention;

FIG. 4 shows a cross-sectional view of a second laminated device embodying the invention;

FIG. 5 shows a perspective exploded view of a third device embodying the invention;

FIG. 6 shows a perspective exploded view of a fourth device embodying the invention;

FIG. 7 shows a substrate defining different structures; 25 FIG. 8 shows a first cut-out lamina;

FIG. 9 shows a second cut-out lamina; and

FIG. 10 shows a partial view of a detection system.

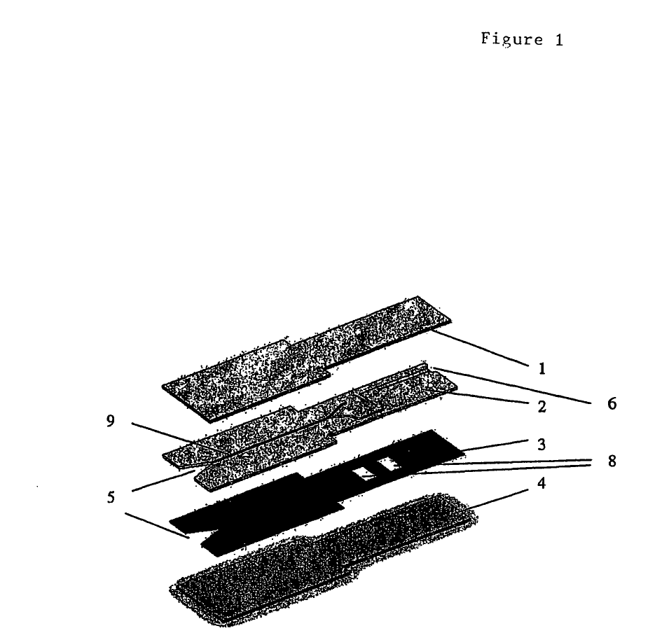

A four member laminated device is shown in FIG. 1. Upper and lower members (1) and (4) sandwich a first intermediate member (2) with channels (9) and a second intermediate member (3) with chamber areas (8). Each member is a thin sheet, and is hereinafter referred to as a lamina.

As may be seen from FIG. 1, intermediate laminae (2) and (3) have microfluidic features cut to the full depth of the material. Lamina (2) is provided with an adhesive coating on its top surface whilst lamina (3) is provided with adhesive coatings on both sides (not shown).

Lamina (2) further contains a sample application feature (5), channelling (9) to transport the fluid sample as well as venting means (6) which serves to vent gases from the chambers (8). Lamina (3) also contains a sample application feature (5).

The venting means may be any suitable. FIG. 1 shows a venting means wherein fluid is prevented from escaping from the device by provision of a capillary stop feature.

The device may be constructed by attaching lamina (3) to lower lamina (4) thus providing a reagent chamber having sidewalls as well as a lower surface. If required, reagent may then be dosed into one or more chambers and allowed to dry. Lamina (2) may then be subsequently attached to lamina (3). Upper lamina (1) may then be attached to lamina (2) to seal the device and close off the channels.

It should be recognized that a key aspect of the invention is to ensure that particular microfluidic elements are separated from one another during construction and that alternative assembly steps could be carried out to those described above. Thus for example according to the device of FIG. 1, construction could be carried out as follows: Attachment of lamina (1) to lamina (2) to form a first lamina sub-assembly A. Attachment of lamina (3) to lamina (4) to form a second lamina sub-assembly B, followed by subsequent attachment of lamina assemblies A and B.

Using this approach, the chamber is separated from the channels whilst dosing the reagent into the chambers thus ensuring that the reagent cannot flow into the channels. Once dried, the reagent is unable to flow into the channels when the device is connected together such that the chamber and channels become fluidically coupled.

In a second embodiment a laminated device was prepared comprising upper and lower laminae, an intermediate lamina with channels cut out, a middle lamina with through holes to fluidically connect the intermediate lamina with channels to the intermediate lamina with reaction chambers and a further intermediate lamina with reaction areas cut out.

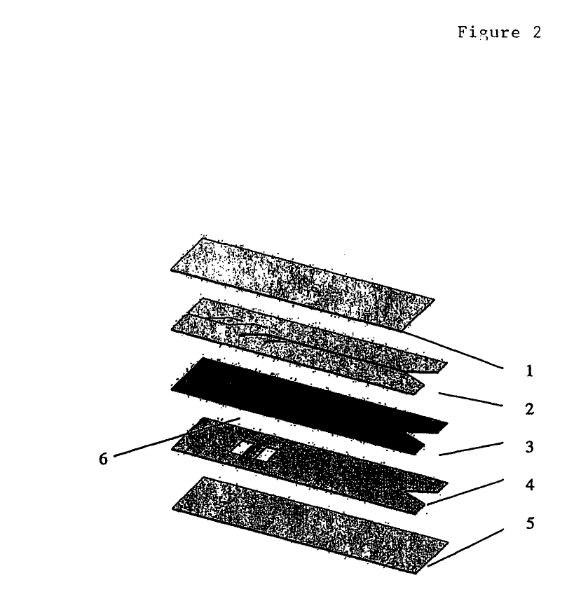

A device prepared from five laminae is shown in FIG. 2. Upper (1) and lower (5) laminae were provided with an intermediate lamina (2) with channel and vent areas, a second intermediate lamina (4) with chamber areas (4) and a middle lamina (3) with through holes (6).

Construction of the device can be achieved for example using a web-based manufacturing process whereby laminae or lamina sub-assemblies can be assembled in independent steps.

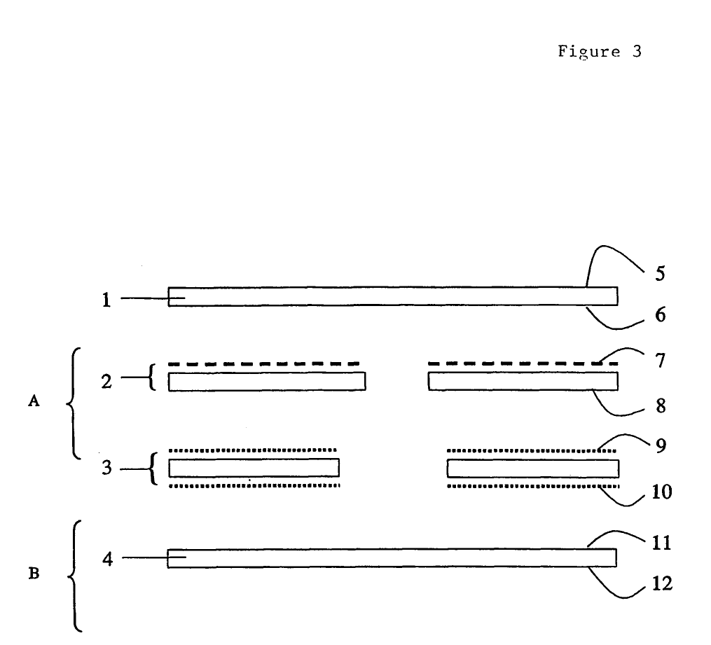

The laminae or lamina sub-assemblies were bonded together. This bonding was achieved through the use of glue laminae on various respective sides of the lamina components. In a preferred embodiment the glue laminae are in the position as shown in FIG. 3.

FIG. 3 shows a cross-sectional view of a four lamina structure device showing the positions of the adhesive layers. Lamina (1) has a top surface (5) that is hydrophobic and a bottom surface (6) that is hydrophilic. Lamina (2) has a top surface that is coated with an adhesive layer (7) and a bottom surface (8) that is hydrophilic. Lamina (3) has top and bottom surfaces that are coated with hydrophilic glue layers (9) and (10). Lamina (4) has a top surface (11) that is hydrophilic and a bottom surface (12) that is hydrophobic.

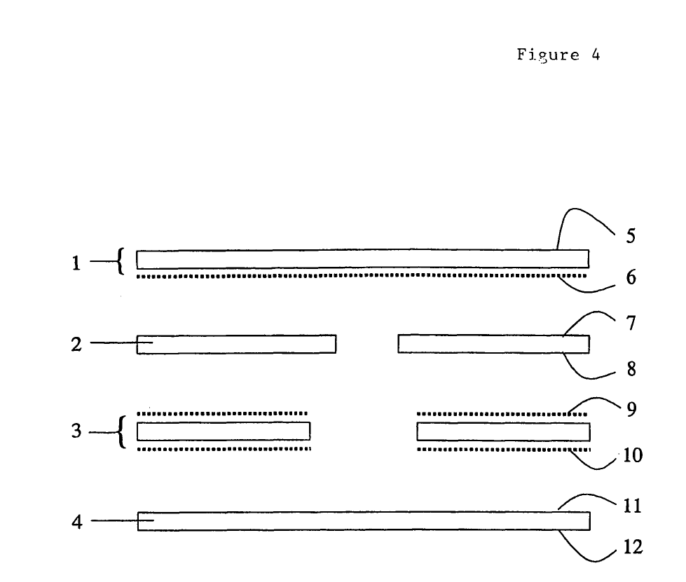

FIG. 4 shows a cross-sectional view of an alternative embodiment of a four lamina structure showing the positions of the adhesive layers. Lamina (1) has a top surface (5) that is hydrophobic and a bottom surface that is coated with a hydrophilic glue layer (6). Lamina (2) has a top surface (7) that is hydrophilic and a bottom surface (8) that is also hydrophilic. Lamina (3) has top and bottom surfaces that are coated with hydrophilic glue layers (9) and (10). Lamina (4) has a top surface (11) that is hydrophilic and a bottom surface (12) that is hydrophobic.

A key aspect of the lamination process is in the provision of a laminated structure wherein certain microfluidic elements of the device are provided which are free from adhesive. A further key aspect is in the provision of adhesives which are either hydrophobic or hydrophilic. Yet a further aspect of the invention is in the provision of laminae having particular hydrophilic or hydrophobic surfaces.

For example in FIG. 3, the chamber element that is defined by laminae (3) and (4) does not have adhesive on the walls defining it. This ensures that reagent or reagents contained within the chamber are not affected by the presence of glue, for example the mobility of particles provided within the chamber. In this particular case, it is preferable that the uncoated surfaces (8) and (11) are made hydrophilic to assist in filling of the chamber element.

Furthermore, as shown in FIG. 3, the upper surfaces of lamina (2) that serve to define a fluid channel are provided with a hydrophilic adhesive. This is to assist the flow of fluid along the channel. In contrast the upper and lower surfaces of lamina (3) are provided with a hydrophobic adhesive which has better adhesive properties, since this particular region does not come into contact with fluid sample.

In general it is desirable to provide hydrophilic inside surfaces that serve to define the microfluidic elements. Furthermore, it is desirable to provide hydrophobic upper and/or lower exterior surfaces, as indicated by (5) and (12) of FIG. 4 as well as a device having hydrophobic sides. This ensures that fluid sample applied to the device is encouraged to flow into the sample application feature.

The invention provides for a low cost manufacturing method and design of devices that are suitable for the measurement of analytes in or the measurement of the properties of low volumes (ranging from less than 1 ul to around 50 ul) of a fluid sample. The invention is particularly suitable for devices having multiple microfluidic elements, especially multiple microfluidic chambers.

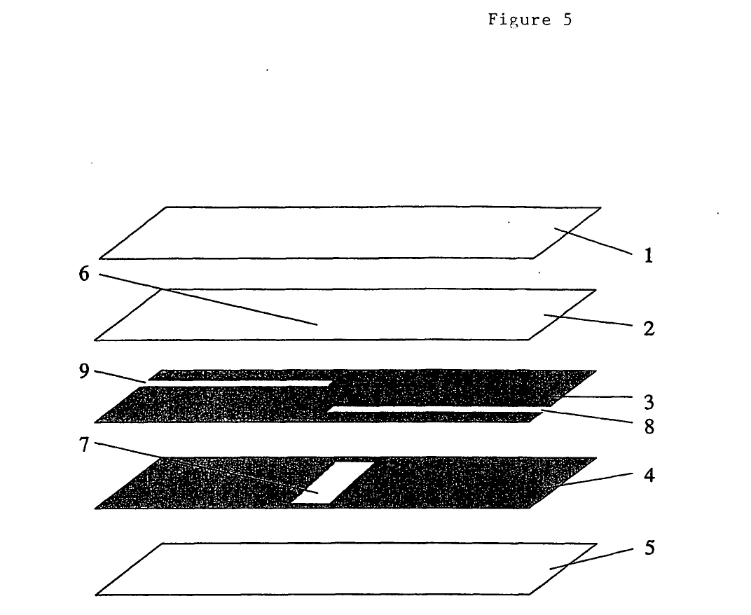

FIG. 5 shows an alternative embodiment whereby the chambers are provided on separate laminae (4) and (2).

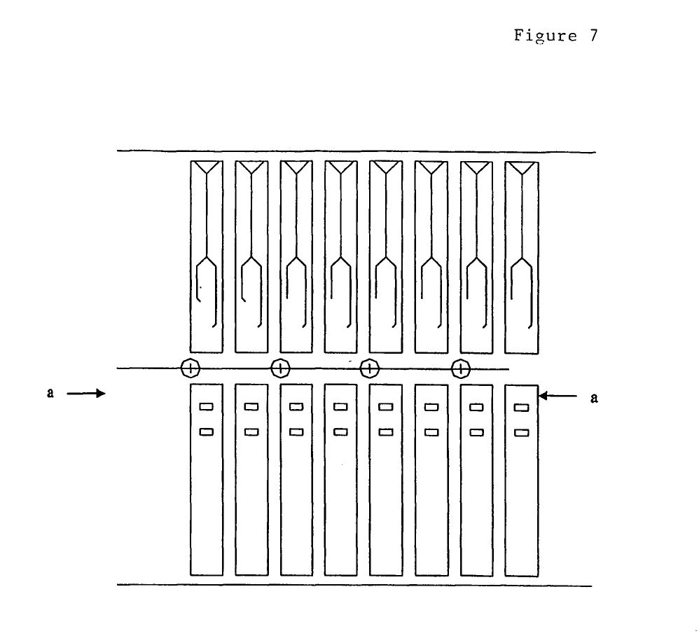

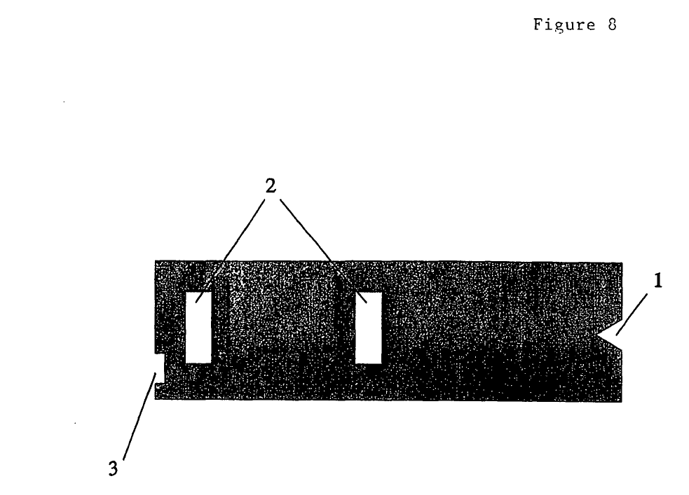

FIG. 7 shows a substrate having various microfluidic structures on one substrate. The substrate may be folded about an axis (a-a) so as to align the respective microfluidic elements. Once the devices have been assembled, the laminated structure may then be cut to provide multiple devices.

FIG. 5 shows a further embodiment wherein the chambers areas (6) and (7) are provided respectively within separate laminae (4) and (2). Furthermore the chamber (6) is situated directly over chamber (7). The two chambers are separated by lamina (3) containing a feed channel (8) and a venting channel (9). In this embodiment when sample is applied to the assembled structure the sample migrates down the feed channel and then moves into chamber (6) and chamber (7). A device wherein the microfluidic elements, in this case detection chambers, are arranged to be situated substantially directly over one another, has the advantage that a single transduction element, such as a solenoid may be arranged such as to cooperate with both detection chambers and removes the need for one transduction element per chamber.

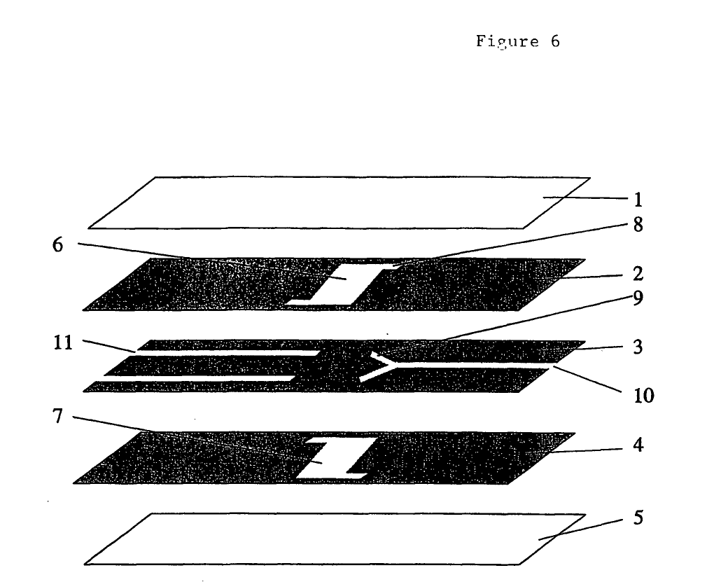

In another embodiment as shown by FIG. 6, a five layer laminated structure (1-5) is provided wherein chamber (6) is provided directly over a chamber (7). The two chambers are separated by lamina (3) containing a feed channel (10) and venting channels (11). Fluidic connection is made from lamina (3) with the chamber (6) in lamina (2) by fluidic overlaps, one leading off the chamber (8) and one leading off the channel (9). Fluidic overlaps are also created to connect the feed channel (10) to chamber (7) and from the chambers (6 and 7) to the venting channels (11). By provision of fluidic overlaps or designing the individual microfluidic elements such that they overlap when assembled it reduces the need for exacting tolerances when assembling the device. Provision of such fluidic overlaps ensures that the individual microfluidic elements are fluidically coupled upon assembly of the device. The invention is not restricted to the fluidic overlaps as indicated by FIG. 6 and other designs could be envisaged, for example provision of a conduit having a circular or wider section at one end.

### EXAMPLE 1

Preparation of Laminae

As exemplified in FIG. 3, a sheet (1) having a hydrophobic upper surface (5) (contact angle greater than 60°) and a hydrophilic lower surface (contact angle less than 30°) was sourced (Tape Specialities Ltd., Hertfordshire, UK). This sheet had a thickness of 175 μm.

A sheet (2) 175 μm thick was cut with a laser (C10, Alltec UK Ltd, Rotherham, UK) in the design as shown in FIG. 8. This sheet had a notch (1) to aid sample filling when the device was constructed, two through holes that create chambers (2) when the device is constructed and a capillary break area (3). This sheet had a 25 μm thick hydrophobic glue layer on the upper surface.

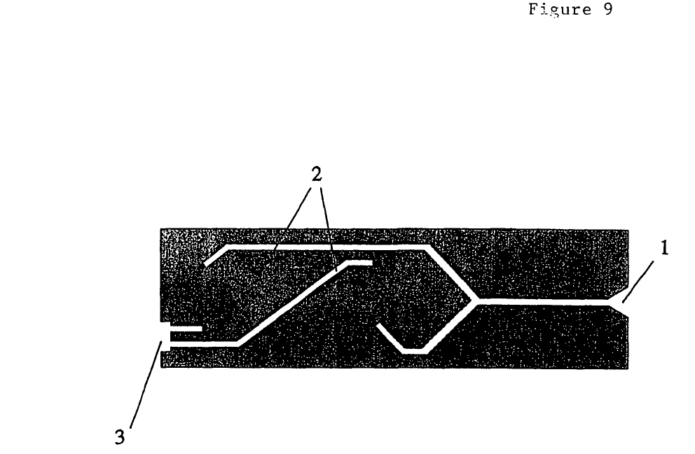

A sheet (3) 175 μm thick was cut with a laser (C10, Alltec UK Ltd, Rotherham, UK) in the design shown in FIG. 9. This sheet had a notch (1) to aid sample filling when the device was constructed, channelling (2) and a capillary break area (3). This sheet had 25 μm hydrophilic glue layers on both the upper and lower surfaces.

A sheet (4) 175 μm thick having a hydrophilic upper surface (contact angle less than 30°) and a hydrophobic lower surface (contact angle greater than 60°) was sourced (Tape Specialities Ltd., Hertfordshire, UK). Laminae (1) and (4) were the same material and differed only in the orientation in which they were used.

Assembly of Lamina Sub-assemblies

The liner covering the upper surface of lamina (2) was removed and the hydrophilic side of lamina (1) was bonded to the exposed glue lamina of lamina (2) by pressing the two materials together. This created a lamina sub-assembly (A).

The liner covering the lower surface of lamina (3) was removed and the hydrophilic side of lamina (4) was bonded to the exposed glue lamina of lamina (3) by pressing the two materials together. This created a lamina sub-assembly (B).

Deposition of Reagents

The lamina sub-assembly (B) was placed such that the two well chambers were uppermost and approx. 50 nl of rabbit brain thromboplastin (prepared by techniques known in the art [for example, U.S. Pat. No. 4,416,812]) was sprayed using an in-house built air brush system across the chambers. This was carried out at a spray rate of 0.16 μl/mm at 0.6 bar spray pressure. Subassembly (B) was subsequently placed on an air-drying machine (Hedinair Ltd., Romford, Essex, UK) and the reagents dried by heating to 55° C. (setting 4) for 6 minutes 20 seconds. Following the deposition of thromboplastin reagent, an aqueous solution of 6% (w/v) in 60% sucrose of superparamagnetic particles having a diameter of approximately 5 μm (Liquids Research Ltd, Bangor, Wales) was sprayed into the chambers at a rate of 0.5 μl/mm. Following this second spraying step, the subassembly was again placed on the air dryer and the reagents dried by heating to 55° C. for 6 minutes and 20 seconds to remove the solvent.

Assembly of Lamina

As shown in FIG. 3, the top liner on subassembly B (9) was removed to reveal the glue layer and this was bonded to the bottom of subassembly (A) by pressing the two materials together. Assembled devices containing dried reagents were stored at 4° C. by sealing in aluminium foil pouches containing a silica desiccant.

Detection of Blood Coagulation

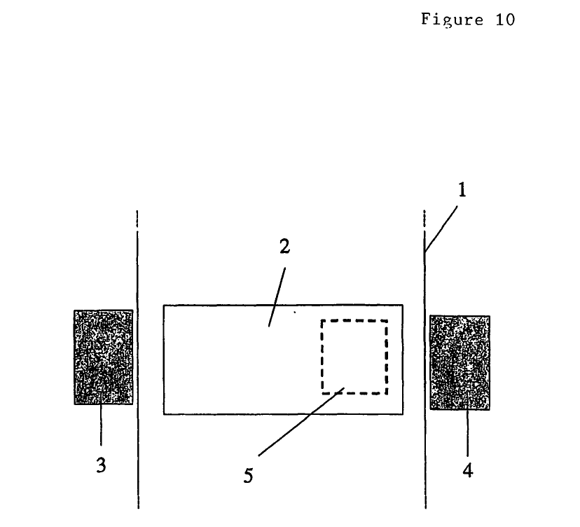

The foil pouch containing the assembled lamina was removed from 4° C. and allowed to equilibrate to room temperature for 5 minutes. The foil pouch was opened and the lamina removed and placed between two electromagnets such that the poles of the magnets were in contact with the side edge of the assembled lamina. FIG. 10 shows a top view of a schematic of the layout of the detection system. The laminated device (1) was oriented such that the chamber (2) was placed in close contact with two electromagnets (3 and 4). An optical assembly consisting of an LED (Everlight Electronics Co, Ltd., Catalogue number 11-21SURC/S530-A3/TR8 with a 632 nm peak emission) and a detector (Everlight Electronics Co, Ltd., Catalogue number PD15-22C/TR8) was placed such that light from the LED interrogated part of a region (5) of the chamber (2). The electromagnets were driven by a simple electrical circuit that passed current at 60 mA into one electromagnet for 250 ms and then switched the 60 mA current into a second electromagnet for 250 ms, this produced a magnetic field with a strength of approx. 40 mT (at the pole). The current was switched between the electromagnets a number of times. Fresh capillary whole blood was added to the front of the lamina. Blood moved by capillary action through the laminated device and entered into the reaction chambers. Upon reaching the reaction chambers the thromboplastin and magnetic particle reagents were resuspended by the blood and the particles began to move backwards and forwards in the reaction chamber due to the force imparted on them by the electromagnets. The LED was illuminated by applying 18 mA and the signal from the detector was collected.

1. A microfluidic device comprising at least four laminae, the laminae including two outer laminae and at least two further laminae disposed between the outer laminae and defining a microfluidic pathway wherein inner surfaces of the outer laminae define the upper and lower surfaces of a fluid pathway, a one of said further laminae defining at least a first fluidic element, and at least a second of said further laminae defining at least a second fluidic element, wherein the first and second fluidic elements are fluidically coupled.

2. A microfluidic device according to claim 1 having at least three further laminae wherein each further laminae defines at least a respective one microfluidic element.

3. A microfluidic device according to claims 1 or 2 wherein a reagent is provided in one or more of the microfluidic elements.

4. A method of constructing a microfluidic device comprising providing at least a first lamina or lamina assembly which serves to define at least a first microfluidic element or area; providing at least a second lamina or lamina assembly which serves to define at least a second microfluidic element or area; and connecting the at least first and second laminae or laminate sub-assemblies such that the first and second microfluidic elements become fluidically coupled.

5. A method according to claim 4 wherein prior to connection of the first and second laminae or lamina assemblies, a reagent is dispensed into one of the microfluidic elements.

6. A method according to claim 5 wherein the reagent is disposed in the particular microfluidic element or elements in a liquid form or dispersed or dissolved in a suitable liquid carrier or liquid solvent.

7. A method according to claim 4, 5 or 6, wherein one of the microfluidic elements is of a higher capillarity than the other.

8. A method according to claim 4,5 or 6 wherein the microfluidic elements are of the same capillarity.

9. A method according to claim 7 wherein reagent is disposed in the microfluidic element having a lower capillarity.

10. A method according to claim 7 or 8 wherein the microfluidic element having a lower capillarity is a fluid chamber and the microfluidic element having a higher capillarity is a fluid conduit.

11. A method according to claim 4 wherein reagents are dispensed into both microfluidic elements.

12. A microfluidic device prepared according to the method of claim 4.

13. A diagnostic assay device prepared according to the method of claim 4.
